(19) United States
(12) Patent Application Publication
(10) Pub. No.: US 2026/0125241 A1
(43) Pub. Date: May 7, 2026

(54) ELEVATOR ARRANGEMENT EXHIBITING ECCENTRIC GUIDE RAILS AND AN ECCENTRIC DRIVE UNIT AS WELL AS USE OF AN ECCENTRICALLY ARRANGED DRIVE UNIT FOR SUCH ELEVATOR ARRANGEMENTS

(71) Applicant: TK ELEVATOR INNOVATION AND OPERATIONS GMBH, Düsseldorf (DE)

(72) Inventors: Raul Matesanz, Parla (ES); Jose Luis Blanco Sánchez, Madrid (ES); Luis Prados, Getafe (ES); Oscar Aglio, Leganes (ES)

(21) Appl. No.: 19/118,101

(22) PCT Filed: Sep. 26, 2023
(86) PCT No.: PCT/EP2023/076575

§ 371 Date: Apr. 3, 2025

(30) Foreign Application Priority Data
Oct. 5, 2022 (EP) 22382933.4

(51) Int. Cl. B66B 7/02; B66B 7/06; B66B 9/00; B66B 11/00

(52) U.S. Cl. CPC B66B 7/021; B66B 7/062; B66B 9/00; B66B 11/0045

(57) ABSTRACT

The present disclosure relates to an elevator arrangement exhibiting at least one cabin and at least one drive unit, wherein the at least one cabin is coupled with the drive unit by traction member interacting with the drive unit in a drive zone, wherein the cabin is guided by cabin guide rails arranged eccentrically according to a horizontal direction/axis with respect to a lift shaft centre line; wherein the drive unit's drive zone is arranged eccentrically with respect to the lift shaft centre line, wherein the cabin guide rail's eccentricity is opposite the drive zone's eccentricity. The eccentricity of the drive zone is at least a predefined/predefinable factor of the eccentricity of the cabin guide rail(s). Such configuration also allows for favourable arrangement of both the cabin guide rail(s) and the drive unit in context with emergency stop situations.

### CROSS REFERENCE TO RELATED APPLICATIONS

This application is a U.S. National Phase application of PCT/EP2023/076575, filed Sep. 26, 2023, which in turn claims priority from European Patent Application No. 22382933.4, filed on Oct. 5, 2022, the disclosure of both which are herein incorporated by reference in their entirety.

### TECHNICAL FIELD

The present disclosure refers to an elevator arrangement exhibiting at least one cabin and at least one drive unit, wherein the at least one cabin is coupled with the drive unit by at least one traction member interacting with the drive unit in a drive zone, wherein the at least one cabin is guided by cabin guide rails respectively arranged eccentrically with respect to a lift shaft centre line or to the respective cabin centre line. The present disclosure also refers to use of at least one eccentrically arranged drive unit for such an elevator arrangement. In particular, the present disclosure refers to elevator arrangements according to the independent claim.

### BACKGROUND

Elevator arrangements exhibiting at least one cabin arranged within a lift shaft are favourably designed such that the lift shaft's dimensions can be slim. Usually, a drive unit and traction member coupling the at least one cabin and the drive unit are arranged on one side of the respective cabin or lift shaft, especially on the side on which a counterweight is guided by means of counterweight guide rails. The at least one cabin is guided by cabin guide rails, wherein at least one cabin guide rail is arranged on the side of the lift shaft on which the drive unit is arranged. Thus, there is a need for a favourable arrangement of at least the cabin guide rail(s) and the drive unit such as the traction member.

The following publications respectively describe an elevator system exhibiting a favourable relative arrangement of guide rails and drive components: CN 111689 343 A, US 2007/102245 A1.

### SUMMARY

It is an object of the present disclosure to provide for an elevator arrangement allowing for a favourable position of the drive unit, especially in view of favourable safety characteristics.

A/the object of the present disclosure is to provide for an elevator arrangement allowing for a favourable position of traction member of the drive unit.

The object of the disclosure is solved by the features of the independent main claims.

Advantageous features are indicated in the subclaims. The features of the subclaims can be combined with the features of the main claims and further subclaims.

The object is therefore solved by an elevator arrangement exhibiting at least one cabin and at least one drive unit, wherein the at least one cabin is coupled with the drive unit by at least one traction member interacting with the drive unit in a drive zone, wherein the at least one cabin is guided by at least one cabin guide rail (such as by a cabin guide rail or by two cabin guide rails arranged on opposite sides of the cabin), wherein the at least one cabin guide rail is arranged eccentrically according to a horizontal direction/axis with respect to a lift shaft centre line; wherein the drive unit's drive zone is arranged eccentrically (y-position in a top view, according to said horizontal direction/axis) with respect to the lift shaft centre line aligned in x-direction (such as with respect to the cabin centre line aligned in x-direction), wherein the eccentricity of the cabin guide rail(s) is opposite the eccentricity of the drive zone (y-position, according to said horizontal direction/axis) such that the drive unit's drive zone is arranged in horizontal distance (y-distance) with respect to the at least one cabin guide rail and also with respect to the lift shaft centre line. According to the teaching of the present disclosure, the eccentricity of the drive zone is dependent on a predefined/predefinable eccentricity of the cabin guide rail(s), wherein the eccentricity of the drive zone is at least a predefined/predefinable factor of the eccentricity of the cabin guide rail(s). This configuration provides for favourable characteristics especially in context with emergency stop behaviour.

This also allows for favourable positions of the traction member(s) within the lift shaft, especially such that the components within the lift shaft do not require much space in x-direction.

The present disclosure is based on the concept of an unbalanced (eccentric) arrangement of the cabin guide rails, and the present disclosure is based on the teaching of eccentrically arranging the drive unit depending on the amount of eccentricity of the cabin guide rails. In contrast to prior art, the present disclosure teaches to eccentrically arrange both the cabin guide rails and the drive unit with respect to a/the cabin centre line, thereby ensuring favourable configurations especially in safety conditions or with respect to system restart after emergency stops.

It should be noted that elevator design is usually driven by most comfortable travelling characteristics in normal/standard operation. Thus, usually, the cabin guide rails are arranged in symmetric configuration, i.e., in balanced manner without any eccentricity. In contrast, the present disclosure focuses on favourable characteristics especially in context with system behaviour in emergency stop situations.

In other words: The present disclosure provides for an arrangement of the traction member (e.g. at least one belt) on one side of the cabin guide rail(s) such that both of the following requirements can be fulfilled in advantageous manner: favourable force attack point of the traction member also in view of an equilibrated cabin, and minimum space requirements also in x-direction. Therefore, all of the following components are arranged (in y-direction) with respect to each other such that overlap in x-direction can be realized: cabin guide rail(s), drive unit and drive zone, counterweight guide rails. For example, a horizontal distance (y-distance) from the cabin guide rail(s) to the centre of the cabin with respect to the lift shaft centre line is 80 mm; for example, a horizontal distance (y-distance) from the cabin guide rail(s) to the drive zone is 180 mm (especially for a belt drive exhibiting two belts) or 207 mm (for example for a belt drive exhibiting three belts). Such eccentric (unbalanced) arrangement also allows for the following advantage: an eccentric arrangement of the guide rail(s) allows for thinner (more slim) supporting material, i.e., the support structure can be designed more cost-effective.

According to the present disclosure, the wording “horizontal direction/axis” refers to one of the two horizontal directions, especially to the direction in which the drive unit's drive shaft is aligned; thus, “horizontal direction” general refers to a spatial alignment (with respect to a coordinate axis) and involves both opposite directions of that spatial alignment; therefore, the term “direction/axis” has been chosen. In general, according to the present disclosure, the wording “horizontal direction” refers to the y-direction shown in the enclosed figure. Thus, according to the present disclosure, the eccentricity of the cabin guide rail(s) and of the drive zone centre is explained by exemplarily referring to the y-coordinate axis (so called second horizontal direction/axis); the skilled person is aware of the fact that the technical teaching of the present disclosure may also be applied to e.g. the x-coordinate axis, especially depending on individual arrangement of guide rails in each individual lift shaft.

According to the present disclosure, the term “x-distance” or “offset distance” refers to a lateral distance according to a/the lift shaft centre line aligned according to a/the first horizontal direction (x-direction), such as arranged according to an alignment of cabin guide rails with respect to each other. According to the present disclosure, the wording “eccentricity” refers to a horizontal direction resp. horizontal distance which is orthogonal to the lift shaft centre line (such as orthogonal to the alignment of cabin guide rails with respect to each other), i.e. to a/the second horizontal direction (y-direction) orthogonal to the first horizontal direction (x-direction). It should be noted that according to the present disclosure, the cabin is assumed to be centrically arranged within the lift shaft with respect to the second horizontal direction (y-direction), such that the cabin is arranged centrically with reference to the space available for the cabin in the corresponding spatial direction (e.g. between a wall of the lift shaft and a door of a station/stop at one of the floors of a building); the skilled person is aware of the fact that the technical teaching of the present disclosure may, alternatively, also refer to the cabin centre line, namely in case the cabin be not arranged centrically within the lift shaft with respect to the second horizontal direction (y-direction). The present disclosure and the claim wording preferably refers to the lift shaft centre line (instead of referring to the cabin centre line) since the guide rails as well as the drive unit may be supported within the shaft; thus, the technical teaching of the present disclosure also refers to shaft design and to the process of arranging and mounting the relevant components within the shaft and supporting them at a wall or on the ground (such as within a pit) of the shaft.

According to one embodiment the cabin guide rail's eccentricity is within the range 50-150 mm, and in some embodiments, within the range 70-110 mm, and wherein the drive zone's eccentricity is at least factor 1.25 of the cabin guide rail's eccentricity. The cabin guide rail's eccentricity is a predefined amount, and the drive zone's eccentricity is determined depending on said minimum factor and depending on a/the individual configuration of the traction member.

According to one embodiment the cabin guide rail's eccentricity and the drive zone's eccentricity are defined such that a/the centre of the drive zone is arranged in a horizontal distance (y-distance) to the lift shaft centre line (resp. to the respective cabin's centre line) at least factor 1.25, and in some embodiments may be more than factor 1.25 of the cabin guide rail's eccentricity. This ensures favourable relative arrangement of both the cabin guide rail(s) and the drive zone, with respect to each other. This also allows for moderate eccentricity in both directions with respect to the lift shaft centre line.

According to the present disclosure the drive unit includes a belt drive, wherein the at least one traction member is a belt, wherein the eccentricity of the drive zone is defined depending on the number of belts, especially based on at least factor 1.25 of the cabin guide rail's eccentricity for a/the belt drive including two belts and based on at least factor 1.55 of the cabin guide rail's eccentricity for a/the belt drive including three belts.

According to one embodiment the eccentricity of the drive zone is at least 3% respectively with respect to the cabin's extension in said horizontal direction and opposite the cabin guide rail's eccentricity. In other embodiments, the eccentricity of the drive zone is at most 6% with respect to the cabin's extension in said horizontal direction and opposite the cabin guide rail's eccentricity. In yet other embodiments, the eccentricity of the drive zone is at most 8% with respect to the cabin's extension in said horizontal direction and opposite the cabin guide rail's eccentricity.

According to one embodiment the drive unit interacts with two belts, wherein the eccentricity of the drive zone is at least 6% and/or at most 8% respectively with respect to the cabin's extension in said horizontal direction and opposite the cabin guide rail's eccentricity.

According to one embodiment the drive unit interacts with three belts, wherein the eccentricity of the drive zone is at least 5% and/or at most 7% respectively with respect to the cabin's extension in said horizontal direction and opposite the cabin guide rail's eccentricity. It should be noted that in a configuration with three belts, the cabin's extension can be bigger than in a configuration with two belts. In other words: Increased loads and/or an increased number of belts may provide for increased cabin extension, e.g. increased by about factor 1.5. The present disclosure teaches to care for eccentricity which differs only slightly when the belt number or the cabin extension are to be scaled.

According to one embodiment the eccentricity of the cabin guide rail(s) is at least 3% with respect to the cabin's (overall) extension in said horizontal direction (such as at least 6% with respect to half the width of the cabin in said horizontal direction). This also favours quite centric arrangement of the drive zone of the drive unit.

According to one embodiment the eccentricity of the cabin guide rail(s) is at most 6% with respect to the cabin's extension in said horizontal direction. This respectively also favours quite centric arrangement of the cabin guide rails, especially such that only two cabin guide rails (vis-à-vis) be required.

In one specific constellation, the eccentricity of the cabin guide rail(s) is about 5.5% with respect to the cabin's (overall) extension.

According to one embodiment the eccentricity of the drive zone is at least 3% with respect to the cabin's (overall) extension in said horizontal direction and opposite the cabin guide rail's eccentricity (such as at least 12% with respect to half the width of the cabin in said horizontal direction).

According to one embodiment the eccentricity of the drive zone is at most 8% with respect to the cabin's extension in said horizontal direction and opposite the cabin guide rail's eccentricity. This also favours quite centric arrangement of the drive zone of the drive unit.

In one specific constellation, the drive zone's eccentricity is about 7% with respect to the cabin's (overall) extension, for a belt drive including two belts.

In another specific constellation, the drive zone's eccentricity is about 9% with respect to the cabin's (overall) extension, especially for a belt drive including three belts.

According to one embodiment the eccentricity of the cabin guide rail(s) is a predefined amount which is irrespective of any specific extension of the cabin in corresponding horizontal direction. Thus, the present disclosure also teaches to preset the cabin guide rail's eccentricity, and to define the drive zone's eccentricity depending thereon. It should be noted that the eccentricity of the cabin guide rail(s) can be a predefined amount which can be defined irrespective of any specific extension of the cabin in corresponding horizontal direction. In other words: According to the teaching of the present disclosure, the eccentricity of the cabin guide rails can be a defined by referring to the cabin's extension, but, according to a some embodiments, the eccentricity of the cabin guide rails is predefined irrespective of the cabin's extension. For example, such a predefined amount is defined depending on load capacity of the elevator arrangement, or depending on maximum height of the elevator arrangement, or depending on maximum speed of the cabin.

According to one embodiment an eccentricity ratio of the drive zone's eccentricity to the cabin guide rail's eccentricity (according to said horizontal direction/axis and with respect to the lift shaft centre line) is at least factor 1.15. This also provides for favourable compromise (trade-off) between eccentric arrangement of the cabin guide rails and eccentric arrangement of the drive zone such as the traction member. In other words: advantageously, the drive zone's eccentricity is not much bigger than the guide rail's eccentricity In some embodiments, the said eccentricity ratio is at most factor 1.3 for a belt drive including two belts. In some embodiments, said eccentricity ratio is at most factor 1.7 for a belt drive including three belts.

It has been found that an arrangement with minimum eccentricity allows for favourable configurations both in view of safety (e.g. in case of emergency stop or system failure) and travelling comfort in standard/normal operation.

It should be noted that belts for belt drives may have a width of about 30-35 mm. Adjacent belts can be arranged, e.g., in a distance of about 50-60 mm. Thus, in this specific constellation, providing three belts instead of only two belts requires additional axial length of about 25-30 mm.

According to one embodiment the drive unit includes a belt drive, wherein the at least one traction member is a belt. This kind of traction member also favours slim design of drive components.

According to one embodiment the drive zone exhibits at least two sections in which a respective belt couples with a/the drive shaft of the drive unit (belt drive). This configuration also allows for scalable design, e.g. by providing further sections on the same drive shaft.

According to one embodiment the at least one cabin is guided by two cabin guide rails arranged on opposite sides of the cabin, wherein the two cabin guide rails are arranged eccentrically with respect to the lift shaft centre line, wherein the two cabin guide rails are arranged with same eccentricity. This configuration also allows for symmetric support and symmetric transmission of forces on both opposing sides of the cabin. Advantageously, the drive unit is arranged on one side of the cabin only.

According to one embodiment the elevator arrangement exhibits guide rails for at least one counterweight and in some embodiments, two counterweight guide rails, which are arranged symmetrically with respect to the drive zone centre (i.e., at the same y-distance in said horizontal direction). This also provides for favourable symmetric arrangement and support with respect to forces transmitted between traction member and the at least one counterweight. In other words: not only the cabin guide rails and the drive unit but also the counterweight guide rails are arranged eccentrically with respect to the lift shaft centre line (X1).

According to one embodiment the drive unit is arranged such that the drive zone and/or the at least one traction member(s) is/are arranged at least approximately at the same horizontal position (x-position) according to the horizontal direction of the lift shaft centre line as the x-position of counterweight guide rails. This also allows for a favourable arrangement of involved components in view of favourable support via the guide rails. A rear section of the traction member may be arranged at said x-position. Advantageously, the drive shaft is arranged at an x-position between the counterweight guide rails and the respective cabin guide rail (referring to the respective side of the cabin), such as at least approximately within the middle, i.e., at half the x-distance.

According to one embodiment the cabin guide rail's eccentricity and the drive zone's eccentricity are defined such that a/the centre of the drive zone is arranged in a horizontal distance to the lift shaft centre line at least factor 1.25 of the cabin guide rail's eccentricity; and wherein the eccentricity of the cabin guide rail(s) is at least 3% and at most 6% with respect to the cabin's extension in said horizontal direction; and wherein the eccentricity of the drive zone is at least 3% with respect to the cabin's extension in said horizontal direction and opposite the cabin guide rail's eccentricity. This configuration provides for considerable advantages on view of above-mentioned aspects.

As such, the above mentioned object is also solved by use of a drive unit arranged eccentrically with respect to a lift shaft centre line for driving at least one cabin of an elevator arrangement, wherein the elevator arrangement exhibits cabin guide rails which are arranged eccentrically in horizontal direction with respect to a lift shaft centre line on one side of the lift shaft centre line, wherein the cabin guide rail's eccentricity is used for defining the amount of the eccentricity of the position of a centre of a drive zone of the drive unit in opposed direction with respect to the lift shaft centre line on the other side of the lift shaft centre line, wherein the drive zone's eccentricity is at least 5% with respect to the cabin's (overall) extension in said horizontal direction (and e.g. and at most 10%), wherein the eccentricity of the drive zone is dependent on a predefined/predefinable eccentricity of the cabin guide rail(s), wherein the eccentricity of the drive zone is at least a predefined/predefinable factor of the eccentricity of the cabin guide rail(s), wherein the drive unit includes a belt drive, wherein the traction member is a belt, wherein the eccentricity of the drive zone is defined depending on the number of belts; and use of said eccentric drive zone arrangement in an elevator arrangement according to the present disclosure. This also provides for above mentioned advantages. The cabin guide rail's eccentricity is at least 5% and at most 10% respectively with respect to the cabin's (overall) extension in said horizontal direction but opposite the drive zone's eccentricity.

Abstract: The present disclosure relates to an elevator arrangement exhibiting at least one cabin and at least one drive unit, wherein the at least one cabin is coupled with the drive unit by at least one traction member(s) interacting with the drive unit in a drive zone, wherein the at least one cabin is guided by at least one cabin guide rail arranged eccentrically according to a horizontal direction/axis with respect to a lift shaft centre line or to the respective cabin centre line; wherein the drive unit's drive zone is arranged eccentrically with respect to the lift shaft centre line, wherein the cabin guide rail's eccentricity is opposite the drive zone's eccentricity such that the zone is arranged in horizontal distance (y-distance) from the cabin guide rail and from the lift shaft centre line. The eccentricity of the drive zone is at least a predefined/predefinable factor of the eccentricity of the cabin guide rail(s). Such configuration also allows for favourable arrangement of both the cabin guide rail(s) and the drive unit especially in context with emergency stop situations.

### SHORT DESCRIPTION OF FIGURES

These and other aspects of the present disclosure will also be apparent from and elucidated with reference to the embodiments described hereinafter. Individual features disclosed in the embodiments can constitute alone or in combination an aspect of the present disclosure.

Features of the different embodiments can be carried over from one embodiment to another embodiment. In the drawings:

FIG. 1 shows in schematic illustration in a top view an elevator arrangement according to embodiments.

### DETAILED DESCRIPTION

First, the reference signs are described in general terms; individual reference is made in connection with the figure.

The present disclosure provides for an elevator arrangement 10 configured for driving at least one cabin 11 arranged within a lift shaft 1 by at least one drive unit 12 exhibiting a drive 13 (especially belt drive) actuating a drive shaft 14.1 providing a drive zone 14 interacting with traction member 15 (especially at least one belt, and in some embodiments, at least two belts), wherein the at least one cabin is guided by cabin guide rails 16, and wherein at least one counterweight (not shown) is guided by counterweight guide rails 17. The cabin 11 is arranged centrically within the lift shaft 1, so a/the lift shaft centre line X1 aligned according to a first horizontal direction (x-direction) is similar to a/the cabin centre line X11 extending in same spatial direction (x), especially with respect to the cabin's extension y11 in said second horizontal direction y. The centre of the drive zone is defined by a drive zone centre (line) X14 (such as the middle/centre of a/the drive shaft axis Y14).

The present disclosure provides for a favourable arrangement of both the cabin guide rails and the drive zone, such as with respect to a/the second horizontal direction (y) which is orthogonal to first horizontal direction. It has been found that such an arrangement also allows for advantageously implementing supporting constituents in context with supporting and fixing the drive unit and the guide rails. A/the y-distance y1 (in the second horizontal direction y) between the respective cabin guide rail 16 and the drive zone centre X14 (the middle of the drive zone) is within the range of 10 to 15% of the cabin's extension in the same direction (y). The eccentricity y 14 (in said second horizontal direction y) of the middle of the drive zone 14 of the drive zone centre X14 is within the range of 6 to 8% of the cabin's extension in the same direction (y). The eccentricity y16 (in said second horizontal direction y) of the respective cabin guide rail 16 is within the range of 4 to 6% of the cabin's extension in the same direction (y). A/the eccentricity factor (ratio) FY of the drive zone eccentricity y14 with respect to the cabin guide rail eccentricity y16 may be in the range of 1.15 to 1.3, i.e., said eccentricity factor (ratio) FY is quite moderate, i.e., the drive zone is not arranged much farer away from the cabin's centre line X11 than the cabin guide rail(s). In other words: the drive zone's offset in y-direction is not much greater than the cabin guide rail's offset in opposing y-direction.

An x-distance x17 (offset distance) between the respective cabin guide rail 16 and the respective counterweight guide rail 17 is marked by reference sign x17.

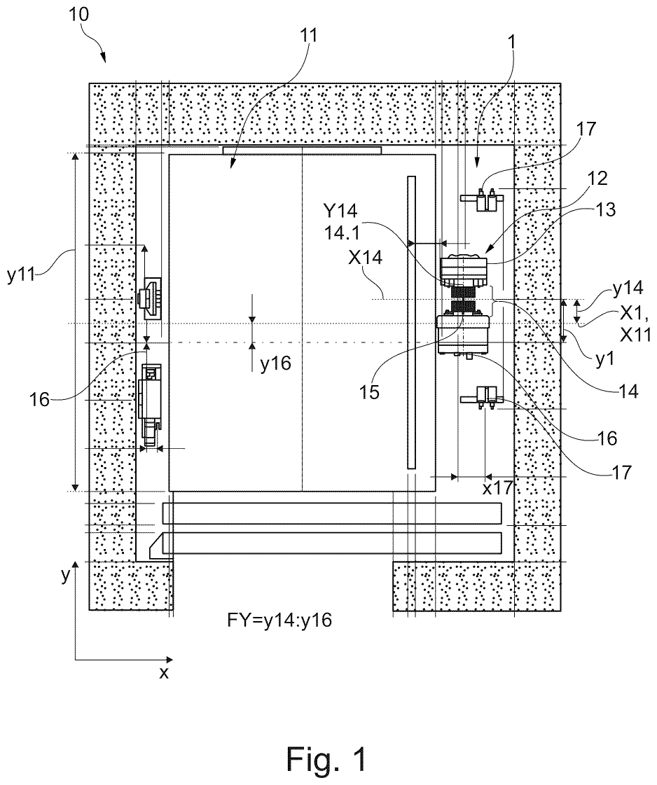

FIG. 1 shows a favourable relative arrangement of the cabin guide rails with respect to the drive zone, in said second horizontal direction (y), but also with respect to the first horizontal direction (x). Eccentricity of the cabin guide rails and the drive zone is nearly the same, but opposite (spatially). FIG. 1 also illustrates an offset distance x between the cabin guide rails 16 and the drive shaft 14.1 (resp. the drive shaft axis Y14) being quite small. FIG. 1 also illustrates an offset distance x between the drive shaft 14.1 and the counterweight guide rails 17 being quite small.

In FIG. 1, the drive unit 12 is illustrated by a dashed line. It should be noted that the drive unit is arranged above the cabin guide rail, i.e., the (eccentric) position of the cabin guide rail does not directly affect/influence the relative position of the drive unit of the belt drive (since the cabin guide rail ends below the drive unit). Thus, a favourable eccentricity factor (ratio) can be found by referring to the drive zone centre.

1. An elevator arrangement comprising:
at least one cabin; and
at least one drive unit,
wherein:
the at least one cabin is coupled with the drive unit by at least one traction member interacting with the drive unit in a drive zone;
the at least one cabin is guided by at least one cabin guide rail which is arranged eccentrically according to a horizontal direction with respect to a lift shaft centre line ;
the drive unit's drive zone is arranged eccentrically with respect to the lift shaft centre line, wherein the eccentricity of the cabin guide rail(s) is opposite the eccentricity of the drive zone such that the drive unit's drive zone is arranged in horizontal distance with respect to the at least one cabin guide rail and also with respect to the lift shaft centre line,
the eccentricity of the drive zone is dependent on a predefined/predefinable eccentricity of the cabin guide rail(s), and
the eccentricity of the drive zone is at least a predefined/predefinable factor of the eccentricity of the cabin guide rail(s), wherein the drive unit having a belt drive, the traction member is a belt, and the eccentricity of the drive zone is defined depending on the number of belts.

2. The elevator arrangement according to claim 1, wherein the cabin guide rail's eccentricity is within the range 50-150 mm, and wherein the drive zone's eccentricity is at least factor 1.25 of the cabin guide rail's eccentricity.

3. The elevator arrangement according to claim 2, wherein the eccentricity of the drive zone is defined depending on the number of belts based on the at least factor 1.25 of the cabin guide rail's eccentricity for the belt drive having two belts and based on at least factor 1.55 of the cabin guide rail's eccentricity for the belt drive having three belts.

4. The elevator arrangement according to claim 2, wherein the eccentricity of the drive zone is at least 3% or at most 6% or 8% respectively with respect to the cabin's extension in said horizontal direction and opposite the cabin guide rail's eccentricity; or
wherein the drive unit interacts with two belts, wherein the eccentricity of the drive zone is at least 6% and/or at most 8% respectively with respect to the cabin's extension in said horizontal direction and opposite the cabin guide rail's eccentricity; or
wherein the drive unit interacts with three belts, wherein the eccentricity of the drive zone is at least 5% or at most 7% respectively with respect to the cabin's extension in said horizontal direction and opposite the cabin guide rail's eccentricity.

5. The elevator arrangement according to claim 1, wherein the at least one cabin is guided by two cabin guide rails arranged on opposite sides of the cabin, wherein the two cabin guide rails are arranged eccentrically with respect to the lift shaft centre line, wherein the two cabin guide rails are arranged with same eccentricity.

6. The elevator arrangement according to claim 1, wherein the elevator arrangement two counterweight guide rails for at least one counterweight, which are arranged symmetrically with respect to a centre of the drive zone.

7. The elevator arrangement according to claim 6, wherein the drive unit is arranged such that the drive zone or the at least one traction member is arranged at least approximately at the same horizontal position according to the horizontal direction of the lift shaft centre line as the x-position of the two counterweight guide rails.

8. The elevator arrangement according to claim 6, wherein the cabin guide rail's eccentricity and the drive zone's eccentricity are defined such that the centre of the drive zone is arranged in a horizontal distance to the lift shaft centre line at least factor 1.25 of the cabin guide rail's eccentricity;
wherein the eccentricity of the cabin guide rail(s) is at least 3% and at most 6% with respect to the cabin's extension in said horizontal direction; and
wherein the eccentricity of the drive zone is at least 3% with respect to the cabin's extension in said horizontal direction and opposite the cabin guide rail's eccentricity.

9. A method for use of a drive unit arranged eccentrically with respect to a lift shaft centre line, the method comprising:
driving at least one cabin of an elevator arrangement,
wherein:
the elevator arrangement having cabin guide rails which are arranged eccentrically in a horizontal direction with respect to the lift shaft centre line on one side of the lift shaft centre line,
the cabin guide rail's eccentricity is used for defining an amount of the eccentricity of the position of a centre of a drive zone of the drive unit in opposed direction with respect to the lift shaft centre line on the other side of the lift shaft centre line,
the drive zone's eccentricity is at least 5% with respect to the cabin's extension in said horizontal direction, wherein the eccentricity of the drive zone is dependent on a predefined/predefinable eccentricity of the cabin guide rail(s),
wherein the eccentricity of the drive zone is at least a predefined/predefinable factor of the eccentricity of the cabin guide rail(s), wherein the drive unit includes a belt drive, wherein the traction member is a belt, and the eccentricity of the drive zone is defined depending on the number of belts.

10. The method according to claim 9, wherein the eccentricity of the drive zone is defined depending on the number of belts based on at least factor 1.25 of the cabin guide rail's eccentricity for the belt drive having two belts.

11. The method according to claim 10, wherein the eccentricity of the drive zone is defined depending on the number of belts based on at least factor 1.55 of the cabin guide rail's eccentricity for the belt drive having three belts.
